(19) United States
(12) Patent Application Publication
(10) Pub. No.: US 2015/0294412 A1
(43) Pub. Date: Oct. 15, 2015

(54) MATCHING ENGINE FOR POLYMORPHIC RIGHTS TO BORROW TRANSACTIONS

(71) Applicant: BANK OF AMERICA CORPORATION, Charlotte, NC (US)

(72) Inventors: Ziyauddin Mohammed Yunus Quraishi, New York, NY (US); Bronislav Shteyngardt, Brooklyn, NY (US)

(73) Assignee: BANK OF AMERICA CORPORATION, Charlotte, NC (US)

(21) Appl. No.: 14/250,090

(22) Filed: Apr. 10, 2014

(51) Int. Cl. G06Q 40/04

(52) U.S. Cl. CPC G06Q 40/04

(57) ABSTRACT

According to yet another embodiment, a system includes an order engine that receives, from a first party, a polymorphic right to borrow sell order. The polymorphic right to borrow sell order includes a first quantity of an asset that is offered for lending, a start date associated with a time when the asset is first offered for lending, an end date associated with a time when the asset is no longer offered for lending, one or more first terms, and one or more second terms different from the one or more first terms. The order engine also receives, from a different party, a right to borrow buy order that indicates a quantity of the asset that is desired for borrowing. The system also includes a matching engine that matches, based upon the one or more first terms and the one or more second terms, the one or more first terms of the polymorphic right to borrow sell order with the right to borrow buy order. The system also includes a transaction engine that determines a transaction associated with the one or more first terms of the polymorphic right to borrow sell order and the right to borrow buy order and initiates the transaction.

### TECHNICAL FIELD

This invention relates, in general, to a matching engine and, more particularly, to a matching engine for rights to borrow orders.

### BACKGROUND

Enterprises, like investment banks and hedge funds, may sometimes desire to borrow a certain quantity of an asset, stock, bond, commodity, or other instrument. Other times, these enterprises may desire to lend out a certain quantity of an asset. Coordinating such borrowing and lending transactions is a resource intensive problem.

### SUMMARY

In accordance with the present disclosure, disadvantages and problems associated with previous systems for borrowing and/or lending securities and other instruments may be reduced or eliminated.

According to one embodiment of the present disclosure, a system includes an order engine that receives, from a first party, a first right to borrow sell order. The first right to borrow sell order includes a first quantity of an asset that is offered for lending, a start date associated with a time when the asset is first offered for lending, an end date associated with a time when the asset is no longer offered for lending, and one or more first terms. The order engine also receives, from the first party, a second right to borrow sell order. The second right to borrow sell order includes the first quantity of the asset that is offered for lending, the start date associated with the time when the asset is first offered for lending, the end date associated with the time when the asset is no longer offered for lending, and one or more second terms different from the one or more first terms. The order engine also receives, from a different party, a right to borrow buy order that indicates a quantity of the asset that is desired for borrowing. The system includes a matching engine that matches, based upon the one or more first terms and the one or more second terms, the first right to borrow sell order with the right to borrow buy order. The system also includes a transaction engine that determines a transaction associated with the first right to borrow sell order and the right to borrow buy order and initiates the transaction. The system also includes an update engine that determines, based upon the first quantity and the quantity of the asset that is desired for borrowing, a remaining quantity and associates the second right to borrow sell order with the remaining quantity.

According to another embodiment, a system includes one or more memory modules that store a plurality of right to borrow sell orders and a plurality of right to borrow buy orders. The system also includes one or more interfaces that receive, from a first party, a first right to borrow sell order. The first right to borrow sell order includes a first quantity of an asset that is offered for lending, a start date associated with a time when the asset is first offered for lending, an end date associated with a time when the asset is no longer offered for lending, and one or more first terms. The one or more interfaces also receive, from the first party, a second right to borrow sell order. The second right to borrow sell order includes the first quantity of the asset that is offered for lending, the start date associated with the time when the asset is first offered for lending, the end date associated with the time when the asset is no longer offered for lending, and one or more second terms different from the one or more first terms. The one or more interfaces also receive, from a different party, a right to borrow buy order that indicates a quantity of the asset that is desired for borrowing. The system also includes one or more processors communicatively coupled to the one or more memory modules. The one or more processors match, based upon the one or more first terms and the one or more second terms, the first right to borrow sell order with the right to borrow buy order. The one or more processors also determine a transaction associated with the first right to borrow sell order and the right to borrow buy order and initiate the transaction. The one or more processors also determine, based upon the first quantity and the quantity of the asset that is desired for borrowing, a remaining quantity and associate the second right to borrow sell order with the remaining quantity.

According to yet another embodiment, a system includes an order engine that receives, from a first party, a polymorphic right to borrow sell order. The polymorphic right to borrow sell order includes a first quantity of an asset that is offered for lending, a start date associated with a time when the asset is first offered for lending, an end date associated with a time when the asset is no longer offered for lending, one or more first terms, and one or more second terms different from the one or more first terms. The order engine also receives, from a different party, a right to borrow buy order that indicates a quantity of the asset that is desired for borrowing. The system also includes a matching engine that matches, based upon the one or more first terms and the one or more second terms, the one or more first terms of the polymorphic right to borrow sell order with the right to borrow buy order. The system also includes a transaction engine that determines a transaction associated with the one or more first terms of the polymorphic right to borrow sell order and the right to borrow buy order and initiates the transaction. The system also includes an update engine that determines, based upon the first quantity and the quantity of the asset that is desired for borrowing, a remaining quantity and associates the polymorphic right to borrow sell order with the remaining quantity.

Certain embodiments of the disclosed system may provide one or more technical advantages. For example, the creation and storage of polymorphic rights to borrow orders may allow the system to conserve memory and bandwidth over a system in which separate orders for the same quantity of an asset are individually transmitted and stored.

In other embodiments, matching rights to borrow buy orders and rights to borrow sell orders based upon considerations that maximize the length of time that the asset is available to be borrowed may save processing power and memory over a system that does not consider the length of the time the asset is available when determining a match. These savings may occur because the system may not perform as many matches since the determined matches will satisfy orders more completely than systems that do not maximize the length of time the asset is available to be borrowed.

In other embodiments, matching rights to borrow buy orders and rights to borrow sell orders based upon considerations that maximize the quantity of the asset available to be borrowed may save processing power and memory over a system that does not consider the quantity of the asset available for borrowing when determining a match. These savings may occur because the system may not perform as many matches since the determined matches will satisfy orders more completely than systems that do not maximize the quantity of the asset available to be borrowed.

Certain embodiments of the disclosed system may include none, some, or all of the above technical advantages. One or more other technical advantages may be readily apparent to one skilled in the art from the figures, descriptions, and claims included herein.

### BRIEF DESCRIPTION OF THE DRAWINGS

For a more complete understanding of the present disclosure, reference is now made to the following description, taken in conjunction with the accompanying drawings, in which:

FIG. 1 illustrates a block diagram of a system operable to manage rights to borrow transactions;

FIGS. 2A and 2B illustrate an example right to borrow buy order and right to borrow sell order, respectively;

FIG. 3A illustrates an example rights to borrow order book;

FIG. 3B illustrates an example rights to borrow order book after the system has initiated certain transactions;

FIG. 4 illustrates an example rights to borrow filled orders book;

FIG. 5 illustrates an example method for managing rights to borrow transactions; and

FIG. 6 illustrates an example polymorphic rights to borrow order.

### DETAILED DESCRIPTION

This disclosure describes a system 10 for coordinating transactions of rights to borrow (RTB) instruments. RTBs facilitate transactions whereby counterparties may borrow or lend assets. An asset, for the purposes of this disclosure, may comprise a stock, a bond, a commodity, or any other instrument that is capable of being borrowed and/or lended. In a traditional asset borrowing and/or lending transaction, a trader may desire to borrow a particular quantity of an asset, sell shares of the borrowed asset on the open market (“short selling”), and return the borrowed shares at a later date (“covering”).

This borrowing and/or lending transaction may prove difficult to complete if the trader wishes to borrow a large number of shares. The trader may have difficulty in locating the requested quantity from parties willing to lend rights to the asset. Numerous transactions may be required, and the coordination of these transactions may prove cumbersome and resource intensive. Additionally, problems may arise if the trader fails to provide collateral for the borrowed asset, if the trader fails to cover at the end of the borrowing period, or if the lending party fails to deliver the asset to the trader.

The use of an RTB instrument may help to alleviate some or all of these problems in certain embodiments. As described above, an RTB instrument facilitates transactions whereby counterparties may borrow or lend assets. An RTB provides its holder with the right to borrow a certain quantity of an asset from a particular lender. The RTB will usually describe additional terms, for instance, the date when the asset will first be borrowed, the date when the asset will no longer be borrowed, and a rental rate to be paid in exchange for borrowing the asset. As such, an RTB may be thought of as a contract between a party who wants the right to borrow a certain quantity of an asset and another party who wants to lend a certain quantity of the asset. The purchase of an RTB may not cause the actual borrowing and/or lending of the asset at issue—as previously described, the RTB instrument sits in front of the asset borrowing and/or lending transaction and may provide only the right to borrow the asset in certain embodiments.

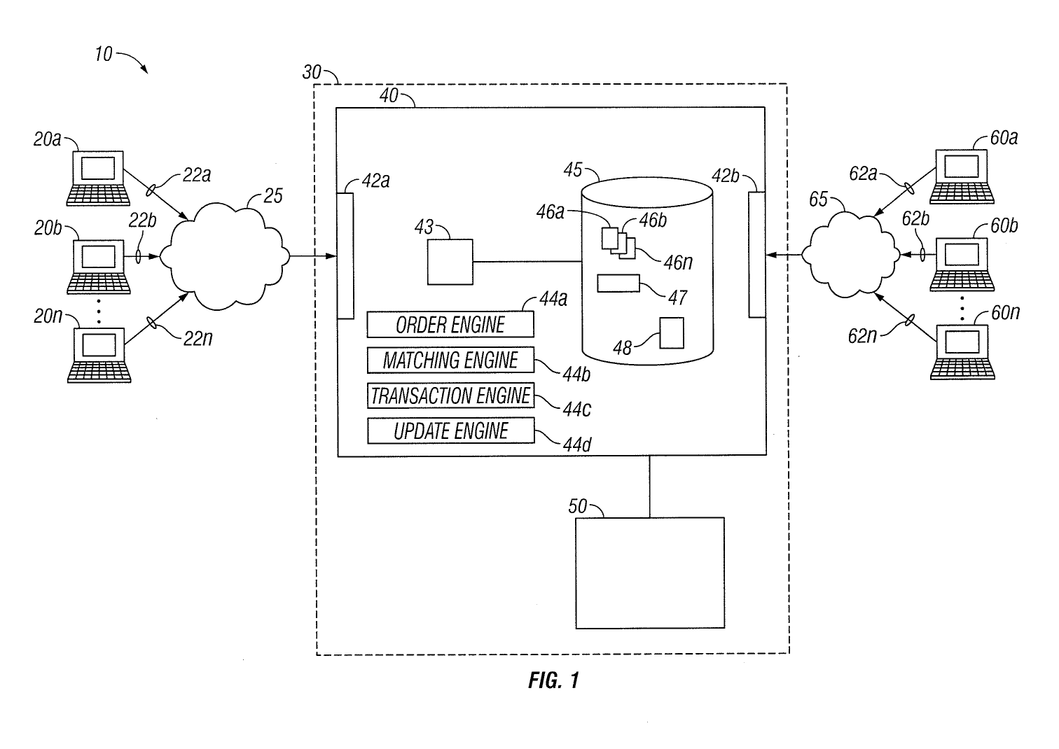

FIG. 1 illustrates system 10 operable to coordinate transactions between rights to borrow buyers and rights to borrow sellers. In general, there are three main parties involved in an RTB transaction: (1) an RTB buyer (illustrated as RTB buyer devices 20), (2) an RTB seller (illustrated as RTB seller devices 60), and (3) an enterprise 30. The RTB buyer may want to buy the right to borrow a certain quantity of an asset for a particular period of time. To do so, the RTB buyer may submit an RTB buy order 22 that describes the terms of a transaction the buyer would find agreeable. The RTB seller owns an asset and may want to sell a right to borrow a certain quantity of that asset for a particular period of time. To do so, the RTB seller may submit an RTB sell order 62 that describes the terms of a transaction the seller would find agreeable. The enterprise 30 is the central party in the transaction and may receive RTB buy orders 22 from RTB buyers and RTB sell orders 62 from RTB sellers. The enterprise 30 may then use a matching engine 44b and matching rules 47 to analyze the received orders and determine whether any RTB buy orders 22 match with any RTB sell orders 62. For instance, the matching engine 44b may determine matches based upon the terms of the RTB buy orders 22 and RTB sell orders 62, including the asset desired to be borrowed and/or lended, the quantity, the start and end dates, and the rental rate, among others.

When a match is determined, a transaction engine 44c may cause the transfer of collateral from the RTB buyer to the enterprise 30. This collateral may be a sufficient amount to cover the current market value of the quantity of the asset specified by the RTB buy order 22. The transaction engine 44c may also cause the transfer of the agreed upon quantity of the asset from the RTB seller to the enterprise 30. The enterprise 30 will hold the collateral and the asset until the RTB buyer decides to exercise its rights under the RTB instrument.

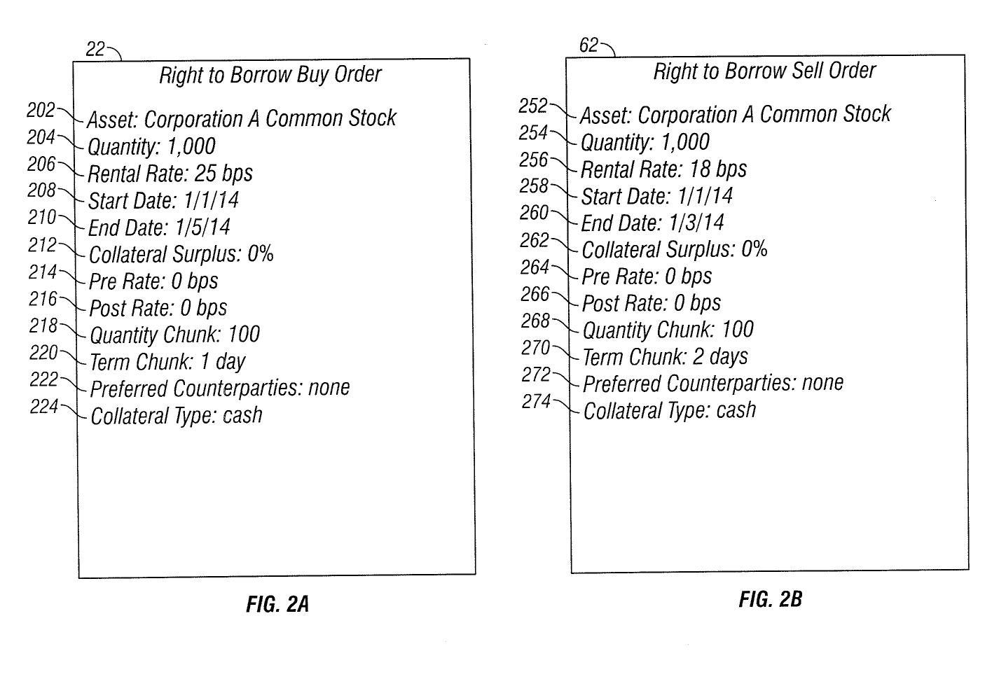

System 10 includes RTB buyer devices 20a-n, RTB seller devices 60a-n, and enterprise 30. As described above, these three parties may coordinate rights to borrow transactions. In certain embodiments, RTB buyer devices 20 may be connected to enterprise 30 through network 25 and may transmit RTB buy orders 22a-n to enterprise 30. An RTB buy order 22 may indicate that an RTB buyer desires to buy the rights to borrow a certain quantity of an asset. RTB buy order 22 may additionally comprise additional terms and conditions of an RTB transaction that the RTB buyer finds agreeable. A detailed example of an RTB buy order 22 will be described in further detail in this disclosure's description of FIG. 2A.

Similarly, in certain embodiments, RTB seller devices 60 may be connected to enterprise 30 through network 65 and may transmit RTB sell orders 62a-n to enterprise 30. An RTB sell order 62 may indicate that an RTB seller desires to sell the rights to borrow a certain quantity of an asset. RTB sell order 62 may additionally comprise additional terms and conditions of an RTB transaction that the RTB seller finds agreeable. A detailed example of an RTB sell order 62 will be described in further detail in this disclosure's description of FIG. 2B. Enterprise 30 may coordinate RTB transactions by matching certain received RTB buy orders 22 with certain received RTB sell orders 62.

System 10 may include any suitable number of RTB buyer devices 20 and RTB seller devices 60. RTB buyer devices 20 and RTB seller devices 60 may include any suitable combination of components that operate to create, manipulate, access, and/or transmit RTB buy orders 22 and RTB sell orders 62, respectively, including a personal computer, a workstation, a laptop, a wireless or cellular telephone or other handheld computing device, an electronic notebook, a personal digital assistant, a tablet, or any other device (wireless, wireline, or otherwise) capable of receiving, processing, storing, and/or communicating information with other components of system 10.

This disclosure contemplates any suitable networks 25 and 65 operable to facilitate communication between the components of system 10. Networks 25 and 65 may comprise a single network or multiple networks and may include any interconnecting system capable of transmitting audio, video, signals, data, messages, or any combination of the preceding. Networks 25 and 65 may include all or a portion of a public switched telephone network (PSTN), a public or private data network, a local area network (LAN), a metropolitan area network (MAN), a wide area network (WAN), a local, regional, or global communication or computer network, such as the Internet, a wireline or wireless network, an enterprise intranet, or any other suitable communication link, including combinations thereof, operable to facilitate communication between the components. Networks 25 and 65 may additionally include any combination of gateways, routers, hubs, switches, access points, base stations, wireless telephone systems and any other hardware, software or a combination thereof.

Enterprise 30 includes an RTB server 40. In certain embodiments, enterprise 30 may utilize RTB server 40 to receive RTB orders, to match certain RTB buy orders 22 with certain RTB sell orders 62, and to initiate transactions associated with the matched orders. RTB server 40 may receive RTB buy orders 22 and RTB sell orders 62 via interfaces 42a and 42b, respectively. Any appropriate number of interfaces 42 may be used, including a single interface 42 that operates to receive both types of RTB orders. Interfaces 42 represent any suitable device operable to receive information from networks 25 and 65, perform suitable processing of the information, communicate to other devices, or any combination of the preceding. Interfaces 42 represent any port or connection, real or virtual, including any suitable hardware and/or software, including protocol conversion and data processing capabilities, to communicate through a LAN, WAN, or other communication systems that allows RTB server 40 to exchange information with the other components of system 10.

RTB server 40 may additionally comprise a processor 43 communicatively coupled with a memory 45. Processor 43 and memory 45 may facilitate the RTB order storage and matching processes performed by RTB server 40. Processor 43 may include any hardware and/or software that operates to control and process information, including RTB order information. Processor 43 may be a programmable logic device, a microcontroller, a microprocessor, any suitable processing device or any suitable combination of the preceding.

RTB server 40 additionally comprises one or more engines 44. Engines 44 perform various functions to coordinate RTB transactions. For instance, in some embodiments, RTB server 40 may include an order engine 44a. Order engine 44a may be communicatively coupled to interfaces 42, processor 43, and memory 45 and may aid RTB server 40 in receiving RTB orders from RTB buyers and sellers.

In some embodiments, RTB server 40 may additionally include a matching engine 44b. Matching engine 44b may aid RTB server 40 in matching RTB orders stored in memory 45. In some embodiments, matching engine 44b indicates that two RTB orders match if certain terms in each RTB order are the same or substantially similar. In some embodiments, matching engine 44b indicates that two RTB orders match if certain terms from each RTB order are related in any appropriate way as indicated by matching engine rules 47. The process of matching RTB orders using matching engine 44b and matching engine rules 47 will be discussed in detail later in this disclosure.

In certain other embodiments, RTB server 40 may include a transaction engine 44c. Transaction engine 44c determines a transaction based upon a matched RTB buy order 22 and RTB sell order 62. For example, in certain embodiments, transaction engine 44c may determine an amount of collateral associated with the transaction, the quantity and type of asset at issue, and various other terms. Transaction engine 44c may additionally initiate the determined transaction. For example, in some embodiments, transaction engine 44c initiates the transfer of the collateral from the RTB buyer to enterprise 30 and the transfer of the quantity of the asset from the RTB seller to enterprise 30. Enterprise 30 may hold the collateral and asset and remain prepared to disperse the asset to the RTB buyer if the RTB buyer decides to exercise its rights under the RTB instrument.

In some embodiments, RTB server 40 includes an update engine 44d. Update engine 44d updates certain RTB buy orders 22 and RTB sell orders 62 stored in memory 45 after a match. Specifically, in certain embodiments, update engine 44d may update any matched RTB orders that are not completely satisfied by the match. For example, if an RTB buy order 22 requested the right to borrow 1,000 shares while the match provided the right to borrow only 500 shares, RTB buy order 22 would not be completely satisfied. Update engine 44d may update any such orders that remain unsatisfied after a partial match to include, for example, a new quantity, a new date range, or any other appropriate terms. Engines 44 may be implemented in any appropriate manner, including by one or more processors, including, but not limited to, processor 43.

RTB server 40 additionally includes a memory 45 that stores data and information—for instance, RTB buy orders 22 and RTB sell orders 62—for use in coordinating rights to borrow transactions. Memory 45 may store, either permanently or temporarily, data, operational software, or other information for processor 43. Memory 45 may include any one or a combination of volatile or non-volatile local or remote devices suitable for storing information. For example, memory 45 may include random access memory (RAM), read only memory (ROM), magnetic storage devices, optical storage devices, or any other suitable information storage device or a combination of these devices.

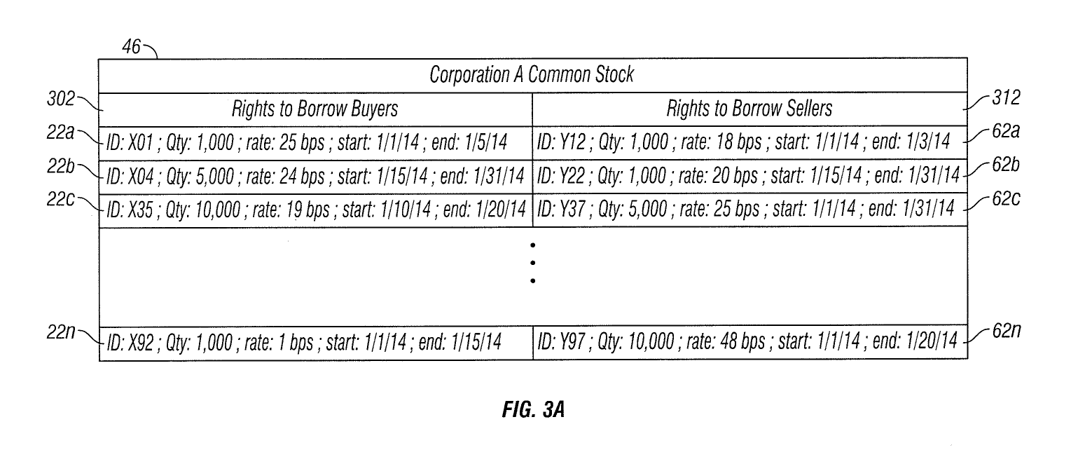

In certain embodiments, memory 45 stores order books 46a-n. Each order book 46a stores RTB buy orders 22 and RTB sell orders 62 for a particular asset. As an example, order book 46a may store RTB buy and sell orders associated with Corporation A's common stock while order book 46b may store RTB buy and sell orders associated with Corporation B's common stock. In another embodiment, order books 46 may store orders across assets and asset classes. Matching engine 44b may use the information stored in order books 46 to determine appropriate matches of RTB buy orders 22 and RTB sell orders 62. Order books 46 will be described in further detail with respect to FIGS. 3A and 3B.

In certain embodiments, memory 45 may additionally comprise RTB matching engine rules 47. Together, RTB matching engine 44b and RTB matching engine rules 47 aid RTB server 40 in determining matches of RTB orders stored in memory 45. The process of matching RTB orders using matching engine 44b and matching engine rules 47 will be discussed in detail later in this disclosure. Matching engine rules 47 may comprise data, an electronic file, software, or any other executable code or module operable to aid matching engine 44c in matching one or more RTB orders.

Memory 45 may additionally comprise a filled orders book 48. When matching engine 44b determines a match, transaction engine 44c may determine a transaction associated with the match and record the transaction in filled orders book 48. An entry in filled orders book 48 may include certain information regarding the filled RTB order, including the quantity of the asset for which the rights to borrow were secured, the rental rate, the time period during which the rights can be exercised, and any other appropriate terms.

In certain embodiments, enterprise 30 may additionally comprise a booking server 50. Booking server 50 may be separate from enterprise 30 or may be integral to enterprise 30. Booking server 50 causes the actual transfer of collateral and the asset between RTB buyers and sellers upon the exercise of an RTB instrument by a buyer. For instance, as described above, enterprise 30 may hold the collateral and asset while an RTB buyer holds an unexercised right to borrow the asset. If the RTB buyer exercises the right to borrow, booking server 50 transfers the asset to the RTB buyer.

In an exemplary embodiment of operation of system 10, an RTB buyer may use RTB buyer device 20 to create an RTB buy order 22. In a particular example, RTB buy order 22 contains information that indicates that the RTB buyer wishes to buy the rights to borrow 1,000 shares of Corporation A common stock from 1/1/14 until 1/5/14 at a rental rate of up to 25 basis points (bps). RTB buyer device 20 then transmits the RTB buy order 22 to RTB server 40. Order engine 44a receives the RTB buy order 22 at interface 42a and stores the order in memory 45. Specifically, order engine 44a determines the particular order book 46 associated with Corporation A common stock and stores RTB buy order 22 in that order book 46.

In this example, an RTB seller may use RTB seller device 60 to create an RTB sell order 62. In this particular example, RTB sell order 62 contains information that indicates that the RTB seller wishes to sell the rights to borrow 1,000 shares of Corporation A common stock starting on 1/1/14 until 1/3/14 at a rental rate of at least 18 basis points (bps). RTB seller device 60 then transmits the RTB sell order 62 to RTB server 40. Order engine 44a receives the RTB sell order 62 at interface 42a and stores the order in memory 45. Specifically, order engine 44a determines the particular order book 46 associated with Corporation A common stock and stores RTB sell order 62 in that order book 46.

In certain embodiments, matching engine 44b analyzes an order book 46 to determine if any RTB buy orders 22 match with any RTB sell orders 62 in that book. In one particular embodiment, matches may be determined only between orders in the same order book 46 because only orders in the same book specify the same asset at interest. In other embodiments, matches may be determined between orders from different order books 46 or between orders that specify differing assets of interest. In this example embodiment, matching engine 44b, based upon matching engine rules 47 and terms associated with the orders stored in order book 46, determines that RTB buy order 22 matches with RTB sell order 62. For example, in a particular embodiment, matching engine 44b may determine that a particular RTB buy order 22 matches with RTB sell order 62 because the terms of the orders are the same or substantially similar.

Further, in certain embodiments, transaction engine 44c determines a transaction associated with the matched orders and creates an entry in filled orders book 48 that contains the agreed upon terms for the transaction. Transaction engine 44c may additionally initiate the transaction, which includes transferring the collateral from the RTB buyer to enterprise 30 and transferring the agreed upon quantity of the asset from the RTB seller to enterprise 30. By holding both the collateral and the asset at enterprise 30, system 10 may minimize the risk associated with borrowing shares of stock. Because enterprise 30 controls the collateral and the asset, the RTB buyer can be assured that the asset will be available for borrowing throughout the lending period, and the RTB seller can be assured that it will receive the fair market value for the asset if the buyer fails to return the asset at the end of the lending period.

Update engine 44d then determines whether any matched RTB orders are not completely satisfied by the determined match. Update engine 44d, upon determining that one or more orders remain unsatisfied after a match, may update the unsatisfied orders in order book 46 according to the terms of the transaction. For example, a match of the above exemplary RTB buy order 22 and RTB sell order 62 would leave RTB buy order 22 unsatisfied. This is because, in this example, RTB buy order 22 desires to borrow the asset until 1/5/14 while RTB sell order 62 desires to lend the asset only until 1/3/14. Thus, in this example, RTB buy order 22 was not completely satisfied by the match because the RTB buyer will not have the right to borrow the desired asset on either 1/4/14 or 1/5/14.

FIG. 2A illustrates an example RTB buy order 22 and its associated terms. In certain embodiments, the information contained in RTB buy order 22 may comprise specific conditions the RTB buyer would agree to in an RTB transaction. These terms may be used by matching engine 44b to create matches between RTB buy order 22 and one or more RTB sell orders 62.

First, RTB buy order 22 specifies an asset 202 desired for borrowing. As described above, asset 202 may comprise a stock, a bond, a commodity, or any other appropriate instrument that is capable of being borrowed and/or lended.

RTB buy order 22 additionally may specify a quantity 204 of asset 202 that is desired for borrowing and a rental rate 206 that may specify the rate the RTB buyer is willing to pay for the right to borrow quantity 204 of asset 202.

The right to borrow buy order 22 may additionally specify a start date 208 associated with a time when asset 202 is first desired to be borrowed and an end date 210 associated with a time when asset 202 is no longer desired to be borrowed.

Collateral surplus 212 may specify an amount of additional collateral the RTB buyer is willing to provide over and above the market price of quantity 204 of asset 202 in exchange for the right to borrow asset 202.

Pre rate 214 may specify an additional rate the RTB buyer is willing to pay to an RTB seller in exchange for locking up the right to borrow asset 202 if start date 208 is a date in the future. For example, a particular RTB sell order 62 may indicate a start date 208 of 1/15/2014. If an RTB buyer buys the RTB sell order 62 before 1/15/2014, the RTB buyer will pay pre rate 214 to the RTB seller until start date 208.

Post rate 216 may specify an additional rental rate the RTB buyer is willing to pay if the RTB buyer returns the borrowed asset 202 earlier than end date 210 agreed upon in the transaction. For example, a particular RTB sell order 62 may indicate an end date 210 of 1/30/2014. If an RTB buyer returns the asset before 1/30/2014, the RTB buyer will pay post rate 216 to the RTB seller until end date 210.

Quantity chunk 218 may specify the minimum quantity of asset 202 that the RTB buyer is willing to buy the rights to borrow for in a single transaction.

Term chunk 220 may specify a minimum amount of time that the RTB buyer is willing to buy the rights to borrow asset 202 in a single transaction.

Preferred counterparties 222 may specify one or more preferred RTB sellers from whom RTB buyer would like to borrow asset 202.

Collateral type 224 may indicate the type of collateral the RTB buyer is willing to provide for in exchange for the right to borrow asset 202. Example collateral types include cash, treasury bonds, and cash equivalents.

The above described terms of RTB buy order 22 are provided for example purposes only. An RTB buy order 22 may include a subset of the above terms and/or additional terms not illustrated in FIG. 2A.

FIG. 2B illustrates an example RTB sell order 62 and its associated terms. In certain embodiments, the information contained in RTB sell order 62 may comprise specific conditions which the RTB seller would agree to in an RTB transaction. These terms may be used by matching engine 44b to create matches between RTB sell order 62 and one or more RTB buy orders 22.

As illustrated in FIG. 2B, in certain embodiments, RTB sell order 62 may comprise substantially the same terms as RTB buy order 22. The meaning of the terms here may vary slightly from the example meanings described above with reference to RTB buy order 22 since the terms may describe conditions to which the RTB seller would agree. For instance, quantity 254 may indicate a quantity of asset 252 that is offered for lending (instead of offered for borrowing), and rental rate 256 may indicate the minimum rate the RTB seller is willing to accept in exchange for selling the right to borrow quantity 204 of asset 252. As another example, start date 258 may be associated with a time when asset 252 is first offered for lending (instead of desired for borrowing) and end date 260 may be associated with a time when asset 252 is no longer offered for lending (again, instead of desired for borrowing). Again, the illustrated terms of RTB sell order 62 are provided for example purposes only. An RTB sell order 62 may include a subset of the illustrated terms and/or additional terms not illustrated in FIG. 2B.

FIG. 3A illustrates an example order book 46. In some embodiments, as described above, an order book 46 may store RTB orders for a single asset—in this example, Corporation A common stock. Order book 46 may be logically separated into two sides: buyer side 302 (illustrated on the left-hand side of order book 46) and seller side 312 (illustrated on the right side of order book 46). As described with reference to FIG. 1, these orders may have been received by order engine 44a from one or more RTB buyers and RTB sellers.

In certain embodiments, the orders stored on buyer side 302 and seller side 312 may be sorted based upon certain criteria. In one example embodiment, RTB buy orders 22 may be sorted in descending order of rental rates while RTB sell orders 62 may be sorted in ascending order of rental rates. In this example embodiment, and as illustrated in FIG. 3A, RTB buy order 22a is at the top of buyer side 302 because it has the highest rental rate (25 bps), and RTB sell order 62a is at the top of seller side 312 because it has the lowest rental rate (18 bps). In certain embodiments, the orders may be sorted in this manner to allow matching engine 44b to create matches more easily. For instance, in certain embodiments, enterprise 30 may determine that it is beneficial to match the top entry on buyer side 302 with the top entry on seller side 312 because this will maximize the difference between the rental rates of the matched orders. Maximizing this difference may, in certain embodiments, lead to higher profits for enterprise 30 since enterprise 30 may be able charge the difference in the rental rates as a fee.

At certain intervals, matching engine 44b may attempt to make matches from among the orders stored in order book 46. For instance, matching may be attempted each time a new order is received by order engine 44a. As another example, matching may be attempted after certain time intervals (e.g., every minute) or if a specific triggering event occurs (e.g., over one hundred orders in order book 46).

In certain embodiments, matching engine rules 47 may cause matching engine 44b to match RTB buy orders 22 with RTB sell orders 62 that have substantially similar terms. Additionally, in some embodiments, matching engine rules 47 may cause matching engine 44b to match RTB buy orders 22 with higher offered rental rates 206 than the requested rental rate 256 of a corresponding RTB sell order 62.

Turning to the example illustrated in FIG. 3A, each of the rental rates 206 of RTB buy orders 22a (25 bps), 22b (24 bps), and 22c (19 bps) are higher than the rental rate 256 of RTB sell order 62a (18 bps). Thus, in this example embodiment, each of RTB buy orders 22a, 22b, and 22c may be matched to RTB sell order 62a. When faced with multiple potential matches, matching engine rules 47 may direct matching engine 44b to select a match according to some additional criteria. For instance, in certain embodiments, matching engine rules 47 may direct matching engine 44b to select a match such that the difference between the rental rates is maximized. In this example, matching engine rules 47 may cause matching engine 44b to match RTB buy order 22a (25 bps) with RTB sell order 62a (18 bps) because it maximizes the difference between the rental rates (7 bps difference). In this embodiment, enterprise 30 may charge the RTB buyer the offered 25 bps rental rate and pay the RTB seller the requested 18 bps rental rate. Enterprise 30 may, in certain embodiments, keep the difference between the rental rate received from the buyer and the rental rate paid by the seller as a fee for coordinating the transaction.

As another example, matching engine rules 47 may direct matching engine 44b to select matches that maximize quantity 204 of asset 202 to be borrowed and/or lended. Returning the example RTB buy orders 22a-c discussed above, matching engine rules 47 may cause matching engine 44b to match RTB buy order 22a (1,000 shares requested) with RTB sell order 62a (1,000 shares offered) since this match completely satisfies the quantity offered and/or requested by both orders. Matching of RTB buy orders 22 and RTB sell orders 62 based upon considerations that maximize quantity 204 of asset 202 may save processing power and memory over a system that does not consider the desired quantity 204 of asset 202 when determining a match. These savings may occur because matching engine 44b may not perform as many matches or fill as many orders since matches will satisfy orders more completely than systems that do not maximize quantity 204 of asset 202 that is available to be borrowed in a transaction.

In certain embodiments, matching engine rules 47 may cause matching engine 44b to determine a match if there is an overlap in the start and end dates 208, 210 for an RTB buy order 22 against the start and end dates 258, 260 of a corresponding RTB sell order 62. Turning to the example illustrated in FIG. 3A, only RTB buy order 22a has start and end dates 208, 210 that overlap with the start and end dates 258, 260 of RTB sell order 62a—specifically, according to this example, the overlap runs from 1/1/2014 through 1/3/2014. Thus, matching engine 44b may determine a match between RTB buy order 22a and RTB sell order 62a.

Matching engine rules 47 may cause matching engine 44b to select a match according to some additional criteria if more than one match exists. For instance, in certain embodiments, matching engine rules 47 may direct matching engine 44b to select a match to maximize the time the asset can be borrowed and/or lended. For example, matching engine rules 47 may select a match that results in asset 202 being available to be borrowed for time period of ten days over a match that results in asset 202 being available to be borrowed for time period of only three days. The matching of RTB buy orders 22 and RTB sell orders 62 based upon considerations that maximize a length of time that asset 202 is available to be borrowed may save processing power and memory over a system that does not consider the length of the time asset 202 is available when determining a match. These savings may occur because matching engine 44b may not perform as many matches or fill as many orders since matches will satisfy orders more completely than systems that do not maximize the length of time the asset is available to be borrowed in a transaction.

In some embodiments, matching engine rules 47 may direct matching engine 44b to consider the remainder of the terms of RTB buy orders 22 and RTB sell orders 62 when determining a match. For instance, RTB matching engine 44b may match orders when collateral surplus 212 of an RTB buy order 22 is greater than or equal to collateral surplus 262 of a corresponding right to borrow sell order 62.

As another example, RTB matching engine 44b may match orders when pre rate 214 of an RTB buy order 22 is greater than or equal to pre rate 264 of a corresponding right to borrow sell order 62. As yet another example, RTB matching engine 44b may match orders when post rate 216 of an RTB buy order 22 is greater than or equal to post rate 266 of a corresponding right to borrow sell order 62.

As yet another example, RTB matching engine 44b may match orders when quantity 204 of an RTB buy order 22 is greater than or equal to quantity chunk 268 of a corresponding right to borrow sell order 62. As yet another example, RTB matching engine 44b may match orders when start date 208 and end date 210 of an RTB buy order 22 comprise a period of time that is greater than or equal to term chunk 270 of a corresponding right to borrow sell order 62. As another example, RTB matching engine 44b may match orders when the RTB buyer associated with an RTB buy order 22 is substantially similar to one or more preferred counterparties 272 of a corresponding right to borrow sell order 62. Finally, RTB matching engine 44b may match orders when collateral type 224 of an RTB buy order 22 is substantially similar to collateral type 274 of a corresponding right to borrow sell order 62. Matching engine rules 47 may cause matching engine 44b to make matches based upon any suitable number of combination of the above considerations. Matching RTB orders based upon these considerations and combinations thereof may save processing power, memory, network bandwidth, and other computing and networking resources over a system that does not take these considerations into account when matching RTB orders.

After matching engine 44b determines a match, transaction engine 44c may determine a transaction associated with the matched orders. In this example, the transaction includes the right to borrow 1,000 shares of Corporation A common stock. The transaction would also indicate that the RTB buyer would pay a rental rate of 25 bps, and the RTB seller would receive a rental rate of 18 bps. The transaction would further indicate that the right to borrow would begin on 1/1/14 and end on 1/3/14. Transaction engine 44c may store such transaction information in filled orders book 48. Transaction engine 44c may also, in certain embodiments, cause the transfer of collateral (including any collateral surplus) from the RTB buyer to enterprise 30, and the transfer of the agreed upon quantity of asset 202 from the RTB seller to enterprise 30. Enterprise 30 may maintain the collateral and asset until the right to borrow expires or the RTB buyer exercises his right to borrow the asset.

In some embodiments, update engine 44d may determine that a match determined by matching engine 44b fails to completely satisfy either the matched RTB buy order 22, the matched RTB sell order 62, or both. For example, a quantity 204, 254 desired for borrowing and/or lending may not be completely satisfied by a match. This may occur, in certain embodiments, if the quantity 204 desired by an RTB buy order 22 is not equal to the quantity 254 offered by an RTB sell order 62. For example, the quantity 204 desired for borrowing may be 5,000 shares while the quantity 254 offered for lending may be 1,000 shares. After the transaction occurs, a quantity 204 desired for borrowing of 4,000 shares will remain for RTB buy order 22.

As another example, the entirety of a period for which asset 202 is desired for borrowing and/or lending may not be satisfied by a match. This may occur, in certain embodiments, if the date ranges for an RTB buy order (as defined by start date 208 and end date 210) and the date ranges for an RTB sell order (as defined by start date 258 and end date 260) are not equal. Indeed, the example match described above did not completely satisfy the date ranges of RTB buy order 22a. In this example, end date 210 for RTB buy order 22a was 1/5/14 while end date 260 for RTB sell order 62a was 1/3/14. Thus, in this example, RTB buy order 22a was not completely satisfied by the match because the RTB buyer will not have the right to borrow asset 202 on either 1/4/14 or 1/5/14. Thus, as a result of this example match, RTB order 22a still requests the right to borrow 1,000 shares of Corporation A common stock for 25 bps from 1/4/14 through 1/5/14.

Upon determining that one or both of the orders were not completely satisfied by the match, update engine 44d may be operable to update the unsatisfied RTB buy orders 22 and RTB sell orders 62 according to the terms of the transaction. For example, update engine 44d may update the quantities 204, 254 desired for borrowing and/or lending and the date ranges associated with the orders. In the example illustrated in FIG. 3A, update engine 44d may update unsatisfied RTB buy order 22a to include a new start date 208 of 1/4/14, which corresponds to the portion of RTB buy order 22a that remained unsatisfied after the match with RTB sell order 62a. In this particular example, the remaining terms may remain the same and are not updated.

FIG. 3B illustrates an example order book 46 after matching engine 44b has determined matches between RTB buy orders 22a and 22b with RTB sell orders 62a and 62b, respectively. As shown, RTB sell orders 62a and 62b are completely satisfied by their respective matches and are thus removed from order book 46. RTB buy orders 22a and 22b, however, were only partially satisfied after their respective matches and have been updated by update engine 44d to reflect the date range (for RTB buy order 22a) or quantity (for RTB buy order 22b) that remains after the partial matches.

For example, matching engine 44b matches RTB buy order 22a with RTB sell order 62a. RTB buy order 22a requested the right to borrow 1,000 shares of Corporation A common stock, and RTB sell order 62b offered the right to borrow the same 1,000 shares of Corporation A common stock. The quantity terms for these two orders completely match, and the RTB buyer will have the right to borrow 1,000 shares. RTB buy order 22a requests the right to borrow the shares from 1/1/14-1/5/14 while RTB sell order 62a offers to the right to borrow the shares only from 1/1/14-1/3/14. As a result, the RTB buyer will have the right to borrow the shares only from 1/1/14-1/3/14. RTB sell order 62a is completely satisfied by this match. RTB buy order 22a, however, is only partially satisfied because the RTB buyer does not have the right to borrow the shares from 1/4/14-1/5/14. Update engine 44d updates RTB buy order 22a to reflect the unsatisfied portion of RTB buy order 22a that remains after the match—specifically, a request to borrow 1,000 shares of Corporation A common stock at a rate of 25 bps from 1/4/14-1/5/14.

As another example, matching engine 44b matches RTB buy order 22b with RTB sell order 62b. RTB buy order 22b requested the right to borrow 5,000 shares of Corporation A common stock while RTB sell order 62b offered the right to borrow only 1,000 shares of Corporation A common stock. The quantity terms for these two orders do not match, and the RTB buyer will have the right to borrow only 1,000 shares, which is 4,000 shares less than requested by RTB buy order 62b. The date terms match exactly since RTB buy order 22b requests the right to borrow the shares from 1/15/14-1/30/14, and RTB sell order 62b offers to the right to borrow the shares only during the same time period. As a result, the RTB buyer will have the right to borrow the shares from 1/1/14-1/3/14. RTB sell order 62b is completely satisfied by this match. RTB buy order 22b, however, is only partially satisfied because the RTB buyer has the right to borrow only 1,000 of the requested 5,000 shares. Update engine 44d updates RTB buy order 22b to reflect the unsatisfied portion of RTB buy order 22b that remains after the match—specifically, a request to borrow 4,000 shares of Corporation A common stock at a rate of 24 bps from 1/15/14-1/30/14.

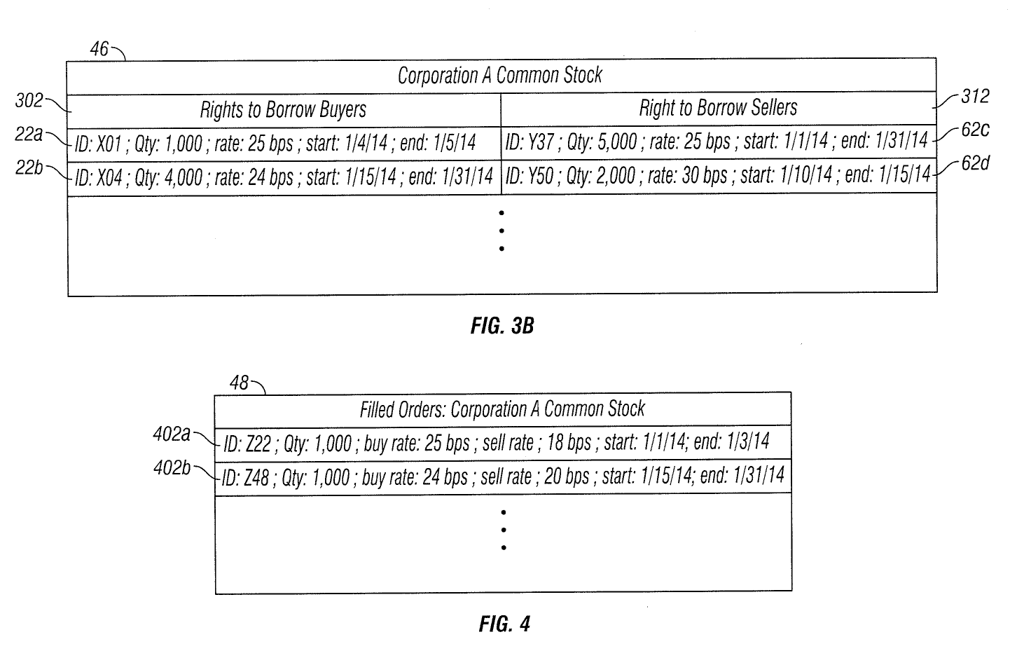

FIG. 4 illustrates an example filled order book 48 after matching engine 44b has determined matches between RTB buy orders 22a and 22b with RTB sell orders 62a and 62b, respectively. As shown, filled order 402a illustrates the transaction determined by transaction engine 44c after RTB buy order 22a was matched with RTB sell order 62a. Similarly, filled order 402b illustrates the transaction determined by transaction engine 44c after RTB buy order 22b was matched with RTB sell order 62b.

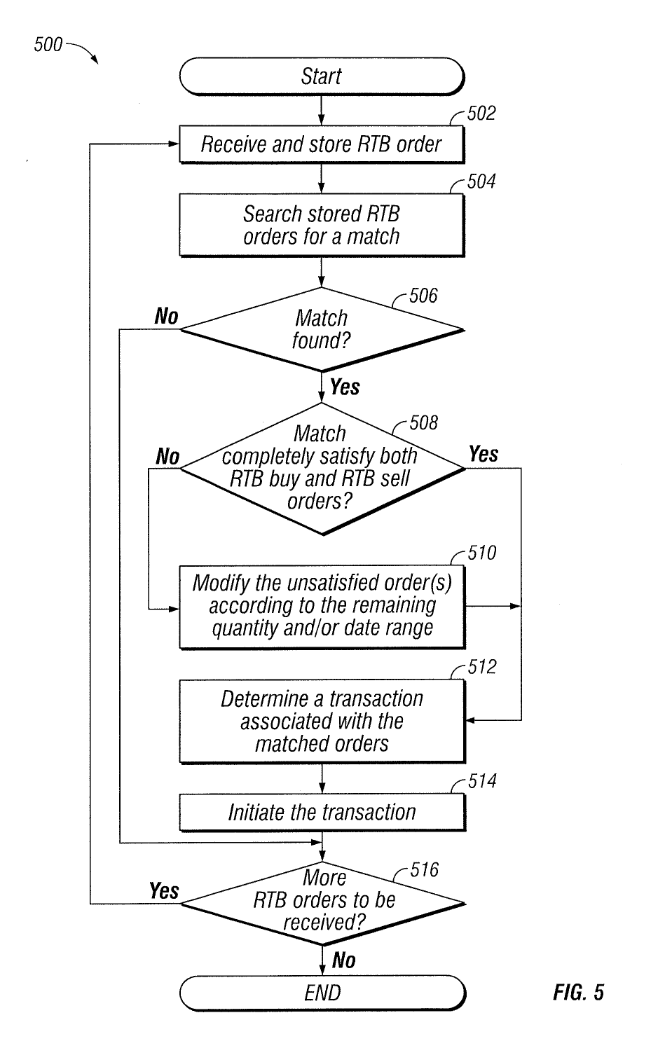

FIG. 5 illustrates an example method 500 for matching RTB buy orders 22 with RTB sell orders 62. Method 500 begins at step 502 when order engine 44a receives an RTB order and stores it in an appropriate order book 46 according to the asset desired to be borrowed. At step 504, matching engine 44b may search order book 46 for one or more RTB orders that match the received order. As previously described, matching engine 44b determine matches based upon logic contained in matching rules 47.

At step 506, matching engine 44b determines whether a match exists for the received RTB order. If no match is found, operation continues to step 516 where order engine 44a determines whether there are more RTB orders to be received. If a match is found, operation continues to step 508 where update engine 44d determines whether the determined match completely satisfies both the RTB buy and the RTB sell orders. As described previously, an RTB order may remain unsatisfied after a match if a quantity of the asset remains to be borrowed and/or lended, if the date ranges for the orders are not equal, and/or if other terms of the RTB orders are not completely satisfied. If update engine 44d determines that at least one of the matched orders remains at least partially unsatisfied, operation continues to step 510 where update engine 44d may modify the unsatisfied RTB orders according to the remaining quantity, date range, and/or other terms.

Whether or not the determined match completely satisfied both orders, operation continues to step 512 where transaction engine 44c determines a transaction associated with the matched orders. As described previously, the determined transaction may comprise the quantity of the asset to be borrowed and/or lended, an amount of collateral associated with the matched orders, and any other additional terms of the matched orders. At step 516, transaction engine 44c initiates the transaction, which may comprise, in some embodiments, causing a transfer of the amount of the collateral from the RTB buyer to enterprise 30 and the transfer of the quantity of the asset to be borrowed and/or lended from the RTB seller to enterprise 30. Operation continues to step 518 where it is determined whether there are more RTB order to be received. If so, operation returns to step 502 where another RTB order is received. If there are no other additional RTB orders to be received, operation ends. The process begins again at step 502 when a new RTB order is received.

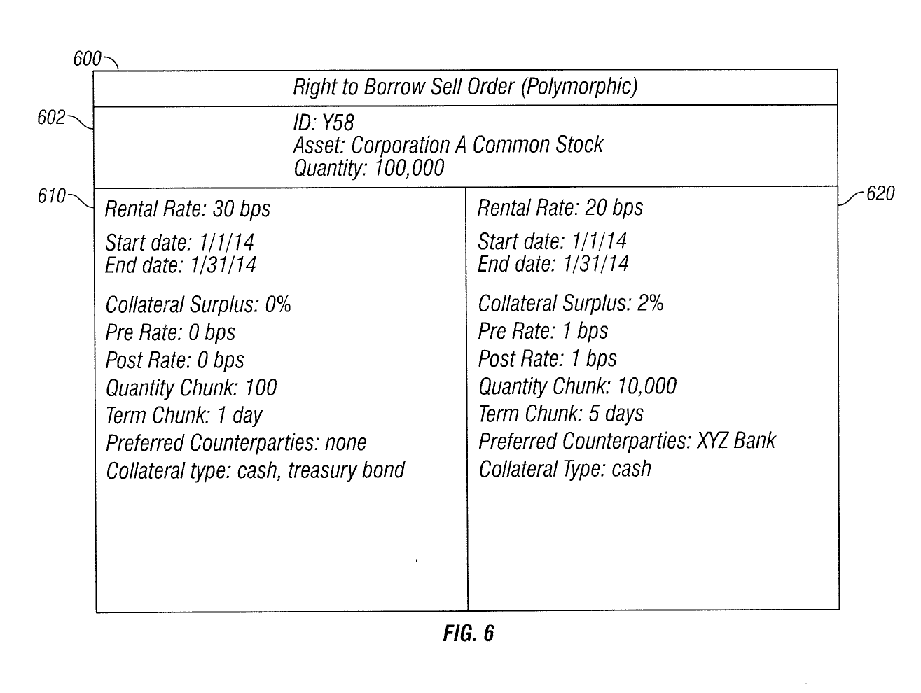

FIG. 6 illustrates an example of a particular type of RTB order—a polymorphic RTB order 600. In general, a polymorphic RTB order 600 is similar in certain respects to a normal RTB order. It may, for example, comprise many of the same terms as a normal RTB order. It may be received from the same parties using the same interfaces 42 and order engine 44a and may be stored in the same order books 46. It may, in certain embodiments, fulfill a similar purpose as a normal RTB order by specifying whether the transmitting party desires to borrow and/or lend a particular quantity of an asset.

A polymorphic RTB order 600 may differ from a normal RTB order, in certain embodiments, however, because it may allow the RTB buyer or seller to create two or more different sets of terms for the same quantity of an asset. Matching engine 44b may then attempt to match RTB orders against each different set of terms contained in a polymorphic RTB order 600. As a result, polymorphic RTB orders 600 may be filled more quickly and more completely than normal RTB orders. This may cause system 10 to save processing power, memory, network bandwidth, and computing and networking resources over a system that does not receive and fill polymorphic RTB orders 600.

A polymorphic RTB order 600 may be created for a single block of an asset. That is, each different set of terms applies to the same shares or quantity of shares of the asset at issue. As an example, an RTB seller may own 10,000 shares of Corporation A common stock and may wish to sell the right to borrow those shares. The RTB seller may create a polymorphic RTB order 600 that specifies the 10,000 shares of Corporation A common stock and then may specify two or more different sets of additional terms to which the RTB seller would be willing to agree. The sets of additional terms may differ, in certain embodiments, in the collateral surplus requested, the type of collateral requested, the requested rental rate, and any other term expressed in a normal RTB order.

The creation and storage of polymorphic RTB orders 600 may allow system 10 to conserve memory and bandwidth over a system in which separate orders for the same quantity of an asset are individually transmitted and stored. This is because the utilization of polymorphic RTB orders 600 may result in system 10 receiving fewer total RTB orders from RTB buyers and sellers since a single polymorphic RTB order 600 may specify several alternative sets of terms and conditions. Additionally, the use of polymorphic RTB orders 600 may cause system 10 to perform fewer total transactions of RTB orders because orders may be satisfied more completely when matched against polymorphic RTB orders 600.

As illustrated in FIG. 6, polymorphic RTB order 600 may comprise a number of static terms 602, which may remain constant and apply to each set of different terms. As an example, static terms 602 may include the asset and the quantity. Thus, any transaction determined from a match of polymorphic RTB order 600 may utilize these static terms. Polymorphic RTB order 600 may comprise two or more different sets of terms. As illustrated in FIG. 6, polymorphic RTB order 600 includes two different sets of terms: first set of terms 610 and second set of terms 620. First set of terms 610 and second set of terms 620 may differ in one or more respects. Using the example illustrated in FIG. 6, first set of terms 610 and second set of terms 620 may comprise different requested rental rates, different collateral surplus amounts, different pre rates, different post rates, different quantity chunks, different term chunks, different collateral types, and different preferred counterparties.

Determining a match for a polymorphic RTB order 600 may be similar to determining a match for a normal RTB order in certain embodiments. Matching engine 44b may attempt to match static terms 602 as well as each of first set of terms 610 and second terms 620 with other normal and polymorphic RTB orders. When a match is determined for polymorphic RTB order 600, transaction engine 44c may determine and initiate a transaction as described previously in this disclosure. Update engine 44d may, in a similar manner as previously described, determine whether the match completely satisfies polymorphic RTB order 600. In certain embodiments, if update engine 44d determines that the match completely satisfies polymorphic RTB order 600 (e.g., quantity and date range terms are completely satisfied), then update engine 44d may remove polymorphic RTB order 600 from order book 46, including all different sets of terms. If, however, the match does not completely satisfy polymorphic RTB order 600, update engine 44d may modify polymorphic RTB order to comprise updated quantity and/or date range terms according to the determined transaction. Such updates may, in certain embodiments, apply to the different sets of terms associated with polymorphic RTB order 600. The updated polymorphic RTB order 600 may then be matched with additional normal RTB orders or other polymorphic RTB orders 600.

In certain embodiments, matching engine 44b may select either first set of terms 610 or second set of terms 620 for matching with other normal and polymorphic RTB orders. Matching engine 44b may make such a selection based upon matching engine rules 47. In certain embodiments, matching engine rules 47 may cause matching engine 44b to select either first set of terms 610 or second set of terms 620 to maximize the difference between the requested and offered rental rates. In other embodiments, matching engine rules 47 may cause matching engine 44b to select either first set of terms 610 or second set of terms 620 to maximize the quantity of the asset that is available for borrowing or to maximize the amount of time the asset is available for borrowing. In certain embodiments, matching engine rules 47 may indicate that other terms from the first set of terms 610 and second set of terms 620 should be considered in making a match.

Although the present invention has been described with several embodiments, a myriad of changes, variations, alterations, transformations, and modifications may be suggested to one skilled in the art, and it is intended that the present invention encompass such changes, variations, alterations, transformations, and modifications as fall within the scope of the appended claims.

What is claimed is:

1. A system, comprising:
an order engine operable to:
receive, from a first party, a first right to borrow sell order, comprising:
a first quantity of an asset that is offered for lending;
a start date associated with a time when the asset is first offered for lending;
an end date associated with a time when the asset is no longer offered for lending; and
one or more first terms;
receive, from the first party, a second right to borrow sell order, comprising:
the first quantity of the asset that is offered for lending;
the start date associated with the time when the asset is first offered for lending;
the end date associated with the time when the asset is no longer offered for lending; and
one or more second terms different from the one or more first terms; and
receive, from a different party, a right to borrow buy order that indicates a quantity of the asset that is desired for borrowing;
a matching engine operable to match, based upon the one or more first terms and the one or more second terms, the first right to borrow sell order with the right to borrow buy order;
a transaction engine operable to:
determine a transaction associated with the first right to borrow sell order and the right to borrow buy order; and
initiate the transaction; and
an update engine operable to:
determine, based upon the first quantity and the quantity of the asset that is desired for borrowing, a remaining quantity; and
associate the second right to borrow sell order with the remaining quantity.

2. The system of claim 1, wherein the order engine is further operable to receive, from the first party, a third right to borrow sell order, comprising:
the first quantity of the asset that is offered for lending;
the start date associated with the time when the asset is first offered for lending;
the end date associated with the time when the asset is no longer offered for lending; and
one or more third terms different from the one or more first terms and the one or more second terms.

3. The system of claim 2, wherein matching the first right to borrow sell order with the right to borrow buy order is further based upon the one or more third terms.

4. The system of claim 3, wherein the update engine is further operable to associate the third right to borrow sell order with the remaining quantity.

5. The system of claim 4, wherein:
the order engine is further operable to receive a second right to borrow buy order that indicates a second quantity of the asset that is desired for borrowing;
the matching engine is further operable to match based upon the one or more second terms and the one or more third terms, the second right to borrow sell order with the right to borrow buy order;
the transaction engine is further operable to:
determine a second transaction associated with the second right to borrow sell order and the second right to borrow buy order; and
initiate the second transaction; and
the update engine is further operable to:
determine, based upon the remaining quantity and the second quantity desired for borrowing, a second remaining quantity; and
associate the third right to borrow sell order with the second remaining quantity.

6. The system of claim 1, wherein the one or more first terms comprise:
a requested rental rate;
a requested collateral surplus
a requested pre rate; and
a requested post rate.

7. The system of claim 1, wherein initiate the transaction comprises:
facilitate a transfer of the quantity of the asset that is desired for borrowing to an enterprise; and
facilitate a transfer of an amount of collateral associated with the quantity of the asset that is desired for borrowing to the enterprise.

8. A system, comprising:
one or more memory modules operable to store a plurality of right to borrow sell orders and a plurality of right to borrow buy orders;
one or more interfaces operable to:
receive, from a first party, a first right to borrow sell order, comprising:
a first quantity of an asset that is offered for lending;
a start date associated with a time when the asset is first offered for lending;
an end date associated with a time when the asset is no longer offered for lending; and
one or more first terms;
receive, from the first party, a second right to borrow sell order, comprising:
the first quantity of the asset that is offered for lending;
the start date associated with the time when the asset is first offered for lending;
the end date associated with the time when the asset is no longer offered for lending; and
one or more second terms different from the one or more first terms; and
receive, from a different party, a right to borrow buy order that indicates a quantity of the asset that is desired for borrowing; and
one or more processors communicatively coupled to the one or more memory modules and operable to:
match, based upon the one or more first terms and the one or more second terms, the first right to borrow sell order with the right to borrow buy order;
determine a transaction associated with the first right to borrow sell order and the right to borrow buy order; and
initiate the transaction; and
determine, based upon the first quantity and the quantity of the asset that is desired for borrowing, a remaining quantity; and
associate the second right to borrow sell order with the remaining quantity.

9. The system of claim 8, wherein the one or more interfaces are further operable to receive, from the first party, a third right to borrow sell order, comprising:
the first quantity of the asset that is offered for lending;
the start date associated with the time when the asset is first offered for lending;
the end date associated with the time when the asset is no longer offered for lending; and
one or more third terms different from the one or more first terms and the one or more second terms.

10. The system of claim 9, wherein matching the first right to borrow sell order with the right to borrow buy order is further based upon the one or more third terms.

11. The system of claim 10, wherein the one or more processors are further operable to associate the third right to borrow sell order with the remaining quantity.

12. The system of claim 11, wherein:
the one or more interfaces are further operable to receive a second right to borrow buy order that indicates a second quantity of the asset that is desired for borrowing; and
the one or more processors are further operable to:
match based upon the one or more second terms and the one or more third terms, the second right to borrow sell order with the right to borrow buy order;
determine a second transaction associated with the second right to borrow sell order and the second right to borrow buy order;
initiate the second transaction;
determine, based upon the remaining quantity and the second quantity desired for borrowing, a second remaining quantity; and
associate the third right to borrow sell order with the second remaining quantity.

13. The system of claim 8, wherein the one or more first terms comprise:
a requested rental rate;
a requested collateral surplus
a requested pre rate; and
a requested post rate.

14. The system of claim 8, wherein initiate the transaction comprises:
facilitate a transfer of the quantity of the asset that is desired for borrowing to an enterprise; and
facilitate a transfer of an amount of collateral associated with the quantity of the asset that is desired for borrowing to the enterprise.

15. A system, comprising:
an order engine operable to:
receive, from a first party, a polymorphic right to borrow sell order, wherein the polymorphic right to borrow sell order comprises:
a first quantity of an asset that is offered for lending;
a start date associated with a time when the asset is first offered for lending;
an end date associated with a time when the asset is no longer offered for lending;
one or more first terms; and
one or more second terms different from the one or more first terms; and
receive, from a different party, a right to borrow buy order that indicates a quantity of the asset that is desired for borrowing;
a matching engine operable to match, based upon the one or more first terms and the one or more second terms, the one or more first terms of the polymorphic right to borrow sell order with the right to borrow buy order;
a transaction engine operable to:
determine a transaction associated with the one or more first terms of the polymorphic right to borrow sell order and the right to borrow buy order; and
initiate the transaction; and
an update engine operable to:
determine, based upon the first quantity and the quantity of the asset that is desired for borrowing, a remaining quantity; and
associate the polymorphic right to borrow sell order with the remaining quantity.

16. The system of claim 15, wherein the polymorphic right to borrow sell order further comprises one or more third terms different from the one or more first terms and the one or more second terms.

17. The system of claim 16, wherein matching the first terms of the polymorphic right to borrow sell order with the right to borrow buy order is further based upon the one or more third terms.

18. The system of claim 17, wherein:
the order engine is further operable to receive a second right to borrow buy order that indicates a second quantity of the asset that is desired for borrowing;
the matching engine is further operable to match based upon the one or more second terms and the one or more third terms, the one or more second terms of the polymorphic right to borrow sell order with the second right to borrow buy order;
the transaction engine is further operable to:
determine a second transaction associated with the one or more second terms of the polymorphic right to borrow sell order and the second right to borrow buy order; and
initiate the second transaction; and
the update engine is further operable to:
determine, based upon the remaining quantity and the second quantity desired for borrowing, a second remaining quantity; and
associate the polymorphic right to borrow sell order with the second remaining quantity.

19. The system of claim 15, wherein the one or more first terms comprise:
a requested rental rate;
a requested collateral surplus
a requested pre rate; and
a requested post rate.

20. The system of claim 15, wherein initiate the transaction comprises:
facilitate a transfer of the quantity of the asset that is desired for borrowing to an enterprise; and
facilitate a transfer of an amount of collateral associated with the quantity of the asset that is desired for borrowing to the enterprise.
